(19) United States
(12) Patent Application Publication
(10) Pub. No.: US 2018/0202419 A1
(43) Pub. Date: Jul. 19, 2018

(54) RESIDENTIAL TURBINE

(71) Applicant: ERNEST CLAYTON, CANTON, MA (US)

(72) Inventor: ERNEST CLAYTON, CANTON, MA (US)

(21) Appl. No.: 15/409,564

(22) Filed: Jan. 19, 2017

(51) Int. Cl. F03D 80/70; F03D 3/00; F03D 3/06; F03D 9/25

(52) U.S. Cl. CPC F03D 80/70; F03D 3/005; F03D 3/065; F03D 9/25; F05B 2240/51; F05B 2240/60; F05B 2280/1071; F05B 2280/5008; F05B 2240/211

(57) ABSTRACT

A vertical axis wind turbine, comprising, a plurality of blades, wherein the blades are an aerofoil, a rotor shaft, the rotor shaft further comprises a rotary section and a stationary section. The plurality of magnet rings further comprises a first magnet ring. The first magnet ring is attached to the rotary section of the rotor shaft and the second magnet ring is attached to the stationary section of the rotor shaft, wherein the first and second magnet rings are cylindrical magnets and comprises a hole in middle of the rings, the first magnet ring is attached to the rotary section of the rotor shaft further consists a particular charge and the second magnet ring is attached to the stationary section of the rotor shaft.

### FIELD OF THE INVENTION

The present invention relates generally to the use of a ring of magnets to suspend a vertical axis wind turbine above the shaft. More specifically, the present invention reduces the friction between the rotating section and the stationary section, which allows the wind turbine to rotate with greater ease and generate more power.

### BACKGROUND OF THE INVENTION

Renewable energy generally relates to energy that can be harnessed from a naturally recurring phenomenon. Hydroelectricity, solar power, and wind power are just some of the examples. Wind power is becoming increasingly more popular power source because wind turbines can be deployed anywhere and have the capability of converting a substantial portion of the kinetic energy to electricity. There are two types of wind turbines currently in use, namely horizontal axis wind turbines and vertical axis wind turbines. Vertical axis wind turbines have many advantages over the horizontal design such as the ability to harness wind blowing from any direction, a compact design, and a lower cost. In current vertical axis wind turbines, the bottom of the blade assembly contacts the shaft, generating friction, reducing the torque acting on the generator, and decreasing the power output.

### SUMMARY OF THE INVENTION:

A vertical axis wind turbine, comprising, plurality of blades, wherein the blades are an aerofoil. The said aerofoils have a high camber, which harness kinetic energy from the wind. A rotor shaft, the rotor shaft further comprises a rotary section and a stationary section. A blade bearing disk, which connect the plurality of blades to the rotary section of the rotor shaft, wherein the blade bearing section further comprises a plurality of L-shape threaded plates, the L-shaped plates are comprised of a top end and a bottom end, the bottom end is attached to the plurality of blades and the top end is attached to the blade bearing disk. A plurality, of magnet rings, the plurality of magnet rings further comprises a first magnet ring. The first magnet ring is attached to the rotary section of the rotor shaft and the second magnet ring is attached to the stationary section of the rotor shaft, wherein the first and second magnet rings are cylindrical magnets and are comprised of a hole in middle of the rings. The first magnet ring is attached to the rotary section of the rotor shaft further consists a particular charge and the second magnet ring is attached to the stationary section of the rotor shaft consisting of a particular charge, wherein the first magnet ring attached to the rotary section by an adhesive means and the second magnet ring is attached to the stationary section by an adhesive means. The magnet rings consist of a particular charge in order to repel one another, reducing friction between the two.

### BRIEF DESCRIPTION OF THE DRAWINGS

FIG. 1 is a close up of the front elevation view of the first example of the present invention.

FIG. 2 is a dose up of the front elevation view of the second example of the present invention.

### DETAILED DESCRIPTION OF THE DRAWINGS

All illustrations of the drawings are for the purpose of describing selected versions of the present invention and are not intended to limit the scope of the present invention.

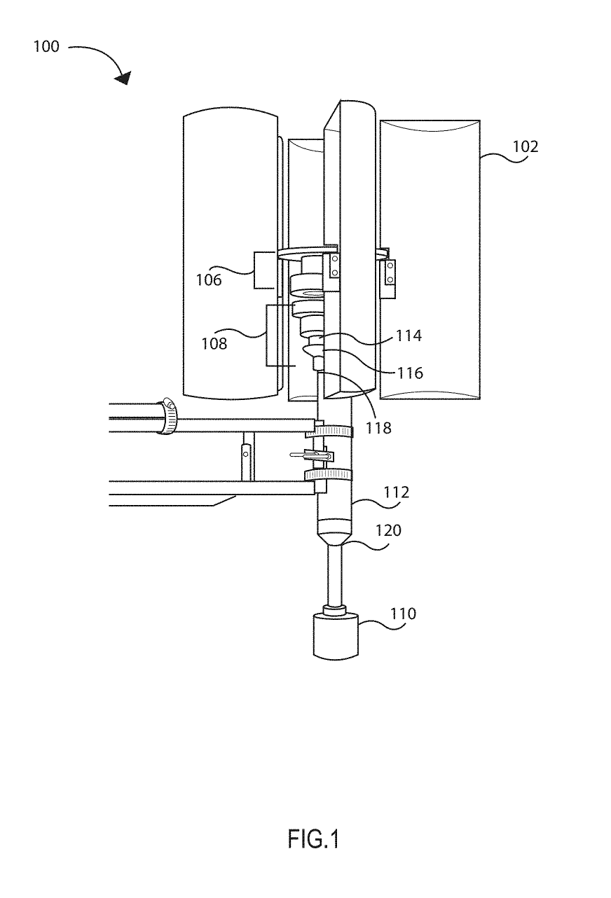

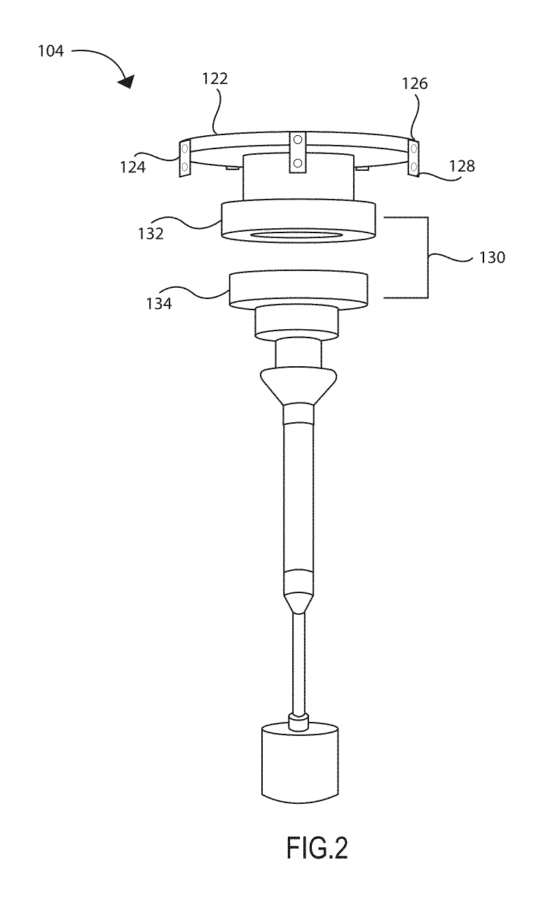

In reference to FIG. 1 and FIG. 2, the rotating section comprises a plurality of blades 102, blades bearing disks 122, a first ring magnet 132, and a rotor shaft 104. The plurality of blades 102 acts as the primary means of harnessing the kinetic energy of the wind. The pluralities of blades 102 are airfoils that operate by generating a pressure differential between the sides of the blades that face the direction of the wind. The pressure differential pushes the airfoil in the direction of the low pressure zone, thus rotating the rotor shaft 104.

In the preferred embodiment of the present invention, the plurality of blades 102 have a high camber, in alternate embodiments, the camber may change to suite the rotation characteristics desired. Preferably, the blades 102 are made of steel, the same material as the wind turbine. The blades 102 can additionally be made of such varied materials such as polymers, composites, alloys, or any other material that is considered to be light and durable enough to operate efficiently and do not necessarily need to be made of the same material as the rest of the turbine.

The present invention utilizes the blades bearing disk 122 to connect the plurality of blades 102 to the rotor shaft 104. The plurality of blades 102 can also be connected to the rotor shaft via a plurality of beams 110 attached to each individual blade, or by means of any other suitable method that is deemed suitable. In the preferred embodiment, the plurality of blades 102 utilizes screws 305 and L-shaped threaded plates 124 to fasten on to the blades bearing disk 122. One side of the L-shaped threaded plate 124 is positioned on the bottom of the blades bearing disk 122 and another on the bottom of the airfoil section of an individual blade 102. Screws 305 are fastened into the threaded holes on the faces of the L-shaped threaded plates 124 which results in a structural bond between the blades bearing disk 122 and the plurality of blades 102.

The rotor shaft 104 comprises a long cylindrical 201 member that extends from the rotating section 106 to the stationary section 108. The upper end of the rotor shaft 104 is engaged to the blades bearing disk 122. The blades bearing disk 122 transfers the rotational torque generated by the plurality of blades 102 to the rotor shaft 104. In order to fully harvest the rotational torque generated by the plurality of blades 102, there is a robust structural bond between the rotor shaft 104 and blades bearing disk 122. Preferably, this bond is a result of the rotor shaft 104 and the blades bearing disk 122 being made from a single piece of material, but any engagement mechanism that results in a strong structural bond is suitable. The lower end of the rotor shaft 104 comprises the rotor part of the generator 110. As the wind rotates the plurality of blades 102, the blades bearing disk 122 transfers the torque to the rotor shaft 104 which operate the generator 110.

The kinetic energy present in the wind is extracted by the plurality of blades 102 in the form of rotational torque. In existing wind turbines, the rotating section 106 engages with the stationary section 108 via mechanisms that require a physical contact between the two components. Depending on the normal force and the coefficient of friction of the materials that come into contact, a parasitic reactionary torque is generated in the direction opposite to the rotation of the rotating section 106. Thus the torque and the energy available to the generator suffer from parasitic friction when the rotating section 106 and the stationary section 108 need to come into contact. The preferred embodiment of the present invention utilizes a first ring magnet 132 with a particular charge and a second ring magnet 134 with the same charge to suspend the rotating section 106 over the stationary section 108 which eliminates the friction generated by the two sections touching each other. The specific charge of the first 132 and second 134 magnets can change in other embodiments, as long as the sides of the first 132 and second 134 ring magnets that face each other have the same charge. The first ring 132 magnet may employ a chemical adhesive, or a suitably robust enjoinment, to attach to a cylindrical extension 201 protruding from the bottom of the blades bearing disk 122. The preferred embodiment of the first ring magnet 132 is a cylindrical magnet with a hole in the middle which allows the rotor shaft 104 to go the stationary section 108. The shape and arrangement of both of the magnets can change to suit the characteristics of the turbine as long as the magnets 130 act as the primary supporting components for suspending the rotating section.

The stationary section 108 comprises of a hollow tube 112, a second ring magnet 134, a rotor shaft 104, a generator 110, a first bearing 114 and a second bearing 116. The top end 118 of the hollow tube 112 is completely open while the bottom end 120 is mostly covered with a circular opening just big enough for the rotor shaft 104 to fit through. The second ring magnet 134 attaches to the hollow tube 112 in a robust manner, preferably by means of a chemical adhesive, in order to efficiently transfer the vertical force exerted by the first ring magnet 132 of the rotating section 106 to the stationary section 108. The hollow tube 112 is a hollow cylindrical tube 114 that acts as the primary load bearing member of the wind turbine. It is responsible for directing the force exerted by the rotating section 106 and the stationary section 108 to an immobile support structure. In the preferred embodiment of the present invention, the turbine relies on a friction bond to engage with a load bearing structure. A U-shaped screw 150 encircles the circumference of the hollow tube 112 and a flat threaded plate 152 fastens to the parallel section of the U-shaped screw 150. Two L-shaped threaded plates 154 are used to connect the assembly to the load bearing structure. One side of the L-shaped threaded plates screws 154 on to the load bearing structure while the other side of the L-shaped threaded plates 152 presses against the flat threaded plate engaged to the parallel sides of the U-shaped screw 150. The flat threaded plate 152 and the L-shaped threaded plates 154 are pressed against each other with sufficient enough force that the friction force generated in the vertical direction is strong enough to withstand the load of the wind turbine.

In another embodiment, the present invention may utilize a chemical adhesive such as tape to attach the middle section of hollow tube 112 to a load bearing structure. Indeed, any fastening method that results in secure enough bond to withstand the vertical load of the wind turbine is suitable for use.

The rotor shaft 104 extends from the rotating section 106 through the stationary section 108 into the generator 110. The bottom end of rotor shaft 104 comprises the rotor of the generator 114. The rotor shaft transfers the torque generated by the rotating section 106 of the wind turbine to the spinning motion of the rotor component of the generator 114. The spinning motion of the rotor 114 is converted into electricity by the generator 110. In the preferred embodiment of the present invention, the generator 110 comprises a rotor 114 that further comprises magnets 130, and a stator 108 that further comprises coils of wires 118. In an alternate embodiment, the generator 110 may take the form of any electrical generator know in the art that converts mechanical energy to electricity. The rotor 106 and the stator 108 of the generator never come into physical contact with each other. The rotor 106 is solely supported by the force the first 132 and second ring magnets 134 produce. The magnetic field generated between the rotor and the stator induces a small force that acts in the opposite direction of the rotation. However, the magnitude of the Induced force is minuscule compared to the friction force produced if the rotating section and the stationary section come into physical contact with each other. The preferred embodiment of the present invention, utilizes three wires 120 that extend from the top of the generator 110 and engage with the bottom of the hollow tube 112 to secure the generator 110 to the turbine. Alternate embodiments may utilize another method to secure the generator 110. For example, the generator may be built into the hollow tube 112. Any securing method that provides structural support for the generator 110 without requiring the rotor 106 to come into contact with any other parts of the wind turbine would be appropriate.

The present invention also utilizes a first bearing 114 and a second bearing 116 in order to preserve the alignment of the rotating section 106 in reference to the stationary section 108. The first bearing 114 encircles the top opening of the second ring magnet 134 and prevents the rotor shaft 104 from straying too far from its position in the centre of the ring 134. The second bearing 116 encircles the circular opening on the bottom of the hollow tube 112. The bearings may be of any type that secure the rotor shaft 104 from moving in the horizontal direction but allow free rotation and movement in the vertical direction.

The present invention allows for multiple embodiments each engaged to different load bearing structure. In one embodiment of the present invention, the wind turbine may be attached to a load bearing member of a building. In yet another embodiment, the area that transfers the load of the turbine to a load bearing support structure may change to suit particular constraints. For example, the hollow tube 112 might be supported by a truss structure which transfers the load directly into the ground. Additionally, in the preferred embodiment of the present invention, all of the components are made of metallic materials. In alternate embodiments each individual component can be made of a separate material that suits the tolerances associated with individual components.

Although the invention has been explained in relation to its preferred embodiment, it is to be understood that many other possible modifications and variations can be made without departing from the spirit and scope of the invention.

What is claimed is:

1. A vertical axis wind turbine, comprising:
a. plurality of blades;
b. a rotor shaft, wherein the rotor shaft further comprises a stationary section and a rotating section;
c. a blade bearing disk, which connects the plurality of blades to the rotor; and
d. plurality of magnet rings, the magnet rings are placed between the stationary section and the rotator section of the rotor shaft.

2. The vertical axis wind turbine of claim 1, wherein the plurality of magnet rings further comprises a first magnet ring and a second magnet ring, the first magnet ring is attached to the rotary section of the rotor shaft and the second magnet ring is attached to the stationary section of the rotor shaft.

3. The vertical axis wind turbine of claim wherein the first and second magnet rings are cylindrical magnets and comprises a hole in middle of the rings.

4. The vertical axis wind turbine of claim 1, wherein the first magnet ring is attached to the rotary section of the rotor shaft further consists a particular charge and the second magnet ring is attached to the stationary section of the rotor shaft consists the particular charge.

5. The vertical axis wind turbine of claim 1, wherein the particular charge is a south pole.

6. The vertical axis wind turbine of claim 1, wherein the particular charge is a north pole

7. The vertical axis wind turbine of claim 1, wherein the first magnet ring attached to the rotary section by an adhesive means and the second magnet ring is attached to the stationary section by the adhesive means.

8. The vertical axis wind turbine of claim 1, wherein the plurality of blades are airfoils.

9. The vertical axis wind turbine of claim 1, wherein the airfoils have high a camber.

10. The vertical axis wind turbine of claim 1, wherein the plurality of blades are made of steel.

11. The vertical axis wind turbine of claim 1, wherein the plurality of blades harness wind kinetic energy.

12. The vertical axis wind turbine, comprising:
a. a rotary section;
b. a stationary section, wherein the stationary section further comprising:
c. a generator;
d. a hallow tube;
e. a second ring magnet;
f. plurality of bearings;
g. a top end and; and
h. a bottom end.

13. The vertical axis wind turbine of claim 12, wherein the second ring magnet is attached to the hollow tube by a means of adhesive.

14. The vertical axis wind turbine of claim 12, wherein the plurality of bearings further comprising a first bearing and a second bearing.

15. The vertical axis wind turbine of claim 12, wherein the first bearing and second bearing is used for used for aligning the rotary section and stationary section.

16. The vertical axis wind turbine of claim 12, wherein the first bearing encircled on the top of second ring magnet, the second bearing encircled on hollow tube.

17. A vertical axis wind turbine, comprising:
a. plurality of blades, wherein the blades are an aerofoil, the said aerofoils have a high camber, which harness wind kinetic energy;
b. a rotor shaft, the rotor shaft further comprises a rotary section and a stationary section;
c. a blade bearing disk, which connect the plurality of blades to the rotary section of the rotor shaft, wherein the blade bearing section further comprises plurality of plurality of L-shape threaded plates, the L-shaped plates comprises a top end and a bottom end, the bottom end is attached to the plurality of blades and the top end is attached to the blade bearing disk; and
d. a plurality of magnet rings, the plurality of magnet rings further comprises a first magnet ring connected to the first magnet ring is attached to the rotary section of the rotor shaft and the second magnet ring is attached to the stationary section of the rotor shaft, wherein the first and second magnet rings are cylindrical magnets and comprises a hole in middle of the rings, the first magnet ring is attached to the rotary section of the rotor shaft further consists of a particular charge and the second magnet ring is attached to the stationary section of the rotor shaft consists the particular charge, wherein the first magnet ring attached to the rotary section by a adhesive means and the second magnet ring is attached to the stationary section by the adhesive means.

18. A vertical axis wind turbine of claim 17, where in the blade, the blade bearing, the rotor shaft are of a metal.

19. A vertical axis wind turbine of claim 17, where in the blade, the blade bearing, the rotor shaft are of an alloy.

20. A vertical axis wind turbine of claim 17, where in the blade, the blade bearing, the rotor shaft are of steel.
